(19) United States
(12) Patent Application Publication
(10) Pub. No.: US 2016/0292604 A1
(43) Pub. Date: Oct. 6, 2016

(54) SYSTEM AND METHOD FOR MANAGING PROSPECTS

(71) Applicant: THE REYNOLDS AND REYNOLDS COMPANY, Kettering, OH (US)

(72) Inventor: Robert T. Brockman, Houston, TX (US)

(21) Appl. No.: 14/968,588

(22) Filed: Dec. 14, 2015

Related U.S. Application Data
(60) Provisional application No. 62/092,067, filed on Dec. 15, 2014.
(60) Provisional application No. 62/138,195, filed on Mar. 25, 2015.

(51) Int. Cl. G06Q 10/06; H04L 12/58

(52) U.S. Cl. CPC G06Q 10/06311; H04L 51/26

(57) ABSTRACT

A method includes establishing predefined communications criteria and generating priority for a series of email, text, recorded dealership employee voice, or direct mail communications with an existing client, and determining if the predefined communications criteria are met for a first communication of the series of communications, the first communication having a first priority. The method also includes determining if the predefined communications criteria are met for any other communication of the series of communications having a higher priority than the first priority and, if one is so found, delaying the first communication, and if not sending the first communication to the existing client.

### CROSS-REFERENCE TO RELATED APPLICATIONS

The present application claims priority from U.S. Provisional Patent Application No. 62/092,067, filed on Dec. 15, 2014, and U.S. Provisional Patent Application No. 62/138,195, filed on Mar. 25, 2015, the entirety of which are incorporated herein by reference.

### TECHNICAL FIELD/FIELD OF THE DISCLOSURE

The present disclosure relates generally to computerized methods for managing prospects for service, leasing, and sales of vehicles.

### BACKGROUND OF THE DISCLOSURE

Dealerships may desire a process for developing and managing existing clients and vehicle services for those existing clients. Management of these existing clients and vehicle services may be complicated by the multiple points at which persons in the dealership that interact with the client and the many potential methods by which the client interacts with those dealership employees. Further, follow-up with existing clients may facilitate purchases and services by those clients that might otherwise not have occurred.

### SUMMARY

The present disclosure provides for a method. The method includes establishing predefined communications criteria and generating priority for a series of email, text, recorded voice of a dealership employee, or direct mail communications with an existing client, and determining if the predefined communications criteria are met for a first communication of the series of communications, the first communication having a first priority. The method also includes determining if the predefined communications criteria are met for any other communication of the series of communications having a higher priority than the first priority and, if one is so found, delaying the first communication, and if not sending the first communication to the existing client.

The present disclosure also provides for a method. The method includes a) assigning a prospect associated with an existing client and b) generating a follow-up activity for the prospect, the follow-up activity being determined by a results-based schedule. The method further includes c) assigning the follow-up activity to a user and d) carrying out the follow-up activity by the user to generate at least one result. The method also includes repeating steps (b)-(d) based at least in part on the result.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flow chart of an existing client prospect management system consistent with at least one embodiment of the present disclosure.

FIG. 2 is a screen shot of an existing client prospect management system consistent with at least one embodiment of the present disclosure.

FIG. 3, including FIGS. 3A-3D, is a screen shot of an existing client prospect management system consistent with at least one embodiment of the present disclosure.

FIGS. 4A and 4B depict a screen shot of an existing client prospect management system consistent with at least one embodiment of the present disclosure.

FIG. 5 is a flow chart of a time-based schedule.

FIGS. 6A and 6B depict a flow chart of a results-based schedule consistent with at least one embodiment of the present disclosure.

FIG. 7 is flow chart of a time-based schedule.

FIG. 8 is a flow chart of a results-based schedule consistent with at least one embodiment of the present disclosure.

FIG. 9, including FIGS. 9A-9D, is a screen shot of an existing client prospect management system consistent with at least one embodiment of the present disclosure.

FIG. 10, including FIGS. 10A-10D, is a screen shot of an existing client prospect management system consistent with at least one embodiment of the present disclosure.

FIG. 11, including FIGS. 11A-11D, is a screen shot of an existing client prospect management system consistent with at least one embodiment of the present disclosure.

FIG. 12, including FIGS. 12A-12D, is a screen shot of an existing client prospect management system consistent with at least one embodiment of the present disclosure.

FIG. 13 is a flow chart of client communications algorithm consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

As used herein, “client” refers to the person or entity who may be interested in purchasing a vehicle, leasing a vehicle, having service done to a vehicle, or purchasing a part from a dealership. An “existing client” is a client with whom the dealership has an existing relationship, such as a previous vehicle purchase, parts purchase, vehicle lease, or vehicle service.

As used herein, “prospect” refers to an opportunity for a vehicle sale, vehicle lease, sale of a part, or vehicle service. A client may have more than one prospect.

As used herein, a “GUI” is a graphical user interface. A GUI may allow data to be displayed and entered. In certain non-limiting embodiments, the GUIs described below may be customized depending on the device on which they are displayed. For instance, my desk prospects GUI 200 as discussed below may display different information when displayed on a computer terminal screen then when displayed on a tablet or smartphone screen.

As described herein, a “user” is any person operating a client prospect management system, such as through, for instance, a GUI.

As used herein, “generate” refers to an action taken by a computer.

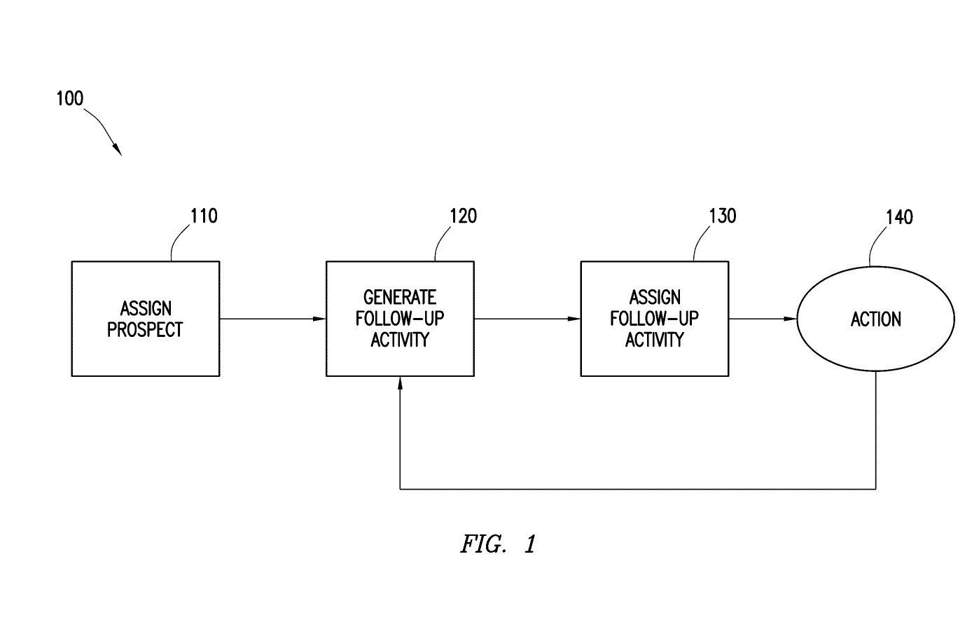

As depicted in FIG. 1, in some embodiments of the present disclosure, existing client prospect management system 100 may include the operations of assign prospect 110, generate follow up activity 120, assign follow-up activity 130 and action 140.

In assign prospect 110, a prospect of the dealership associated with an existing client is assigned to an employee of the dealership. In certain embodiments, such as prospects associated with existing clients who have purchased a vehicle from the dealership, leased a vehicle from the dealership, had service performed on a vehicle at the dealership, or ordered a part from the dealership, the prospect may be assigned to a salesperson, sales manager, service employee, or service manager.

A prospect may be assigned in assign prospect 110 by an employee of the dealership, such as a dealership sales manager or service manager, or by a rules engine. For sales prospects, which may include both vehicle sales and vehicle leases, the rules engine may consider such assignment factors as which salesperson, if any, made a vehicle sale or vehicle lease to the existing client associated with the prospect, when a salesperson became available for receiving prospects, the ranking of a salesperson (such as a ranking of the salesperson's skills or effectiveness by a dealership manager), ineligibility for assignment of a prospect due to incomplete tasks, and assignment rotation. “Assignment rotation” means that the rules engine may consider which salesperson was last assigned a prospect and may then consider the next salesperson on a predefined list of salespersons. Assignment rotation may skip listed salespersons, for instance, if a salesperson is absent or otherwise not available. In some embodiments, assignment rotation may also consider the other assignment factors. For service prospects, which may include both vehicle service prospects and parts prospects, the rules engine may consider if a service employee has an existing relationship with an existing client or assignment rotation, as described above with respect to sales prospects. “Assigned” means that the employee such as the salesperson or service employee is responsible for interaction with the existing client associated with the prospect for such tasks as, for instance and without limitation, adding information about the client or the prospect into the dealership's prospect database, communicating with the existing client, updating the existing client with respect to status of the vehicle, and interfacing between the existing client and other service employees. In certain embodiments of the present disclosure, assign prospect 110 may include receiving signals from input devices and databases representing such physical aspects as information about the existing client, and information about the prospect into a computer system. Assign prospect 110 may use one or more GUIs to collect and display prospects, as described further below.

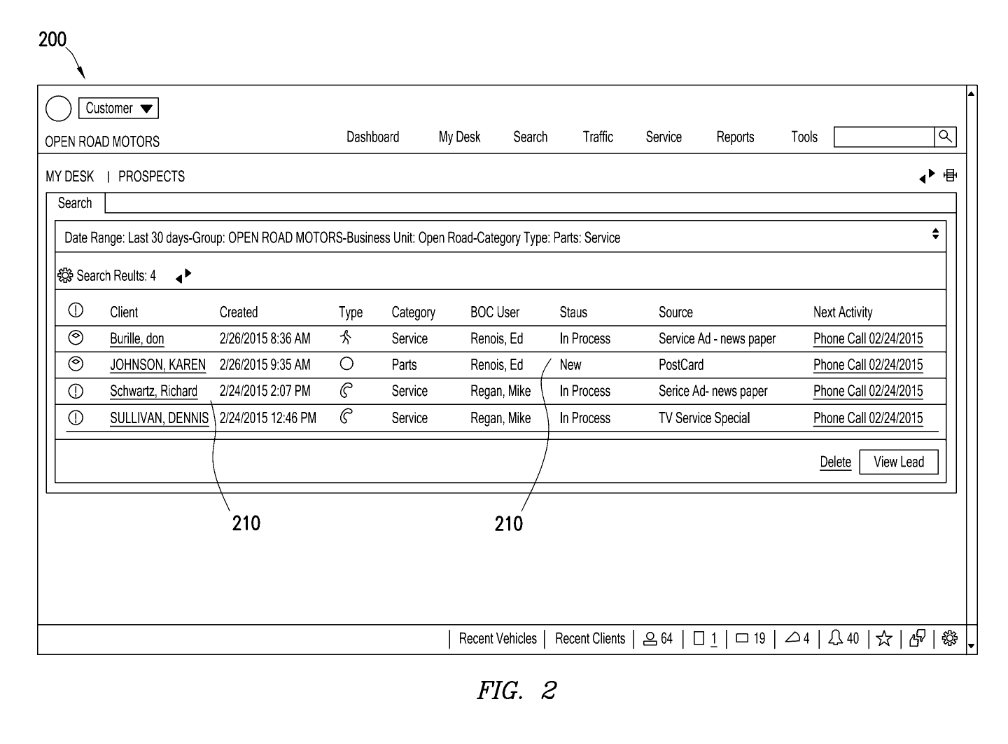

In some embodiments of the present disclosure, as depicted in FIG. 2, as part of assign prospect 110, a plurality of prospects, two of which are shown as a plurality of prospects 210, may be displayed in my desk prospects GUI 200. The embodiment of my desk prospects GUI 200 in FIG. 2 depicts service prospects and parts prospects, but my desk prospects GUI 200 may also display vehicle sales prospects and vehicle lease prospects. In the embodiment of my desk prospects GUI 200 shown in FIG. 2, prospect 210 may be associated with prospect information such as, for example and without limitation, the existing client, the date the prospect was created, type of contact made with the existing client, the category for the prospect (for instance, without limitation, parts, service, sale, or lease), the user responsible for the prospect (entitled BDC User in service prospect 210), the status of the prospect, the source of the prospect and the next activity scheduled for the prospect. Information associated with prospect 210 may be displayed by my desk prospects GUI 200. In some embodiments, the source of the prospect may include, without limitation internet, radio, television, social media such as Facebook, service ad, post card, and billboards. My desk prospects GUI 200 may be configurable to, for instance in certain embodiments, display to an individual user such as a service advisor or sales person all of the prospects currently associated with that user. Prospect information may be stored in non-transitory, tangible computer readable storage medium.

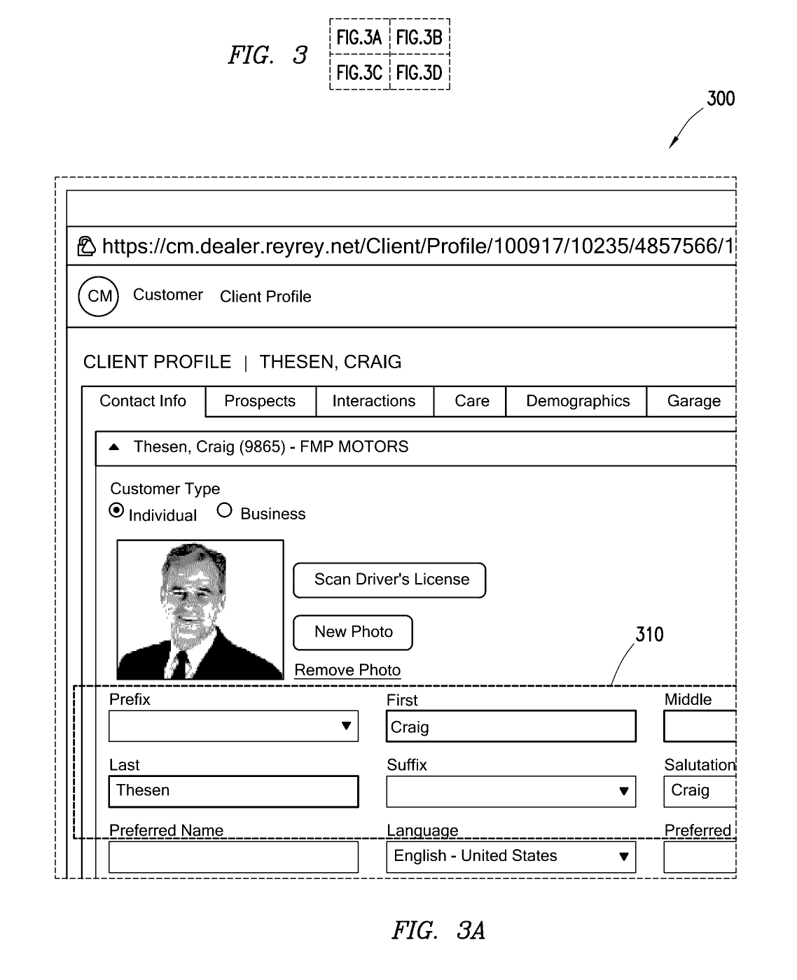

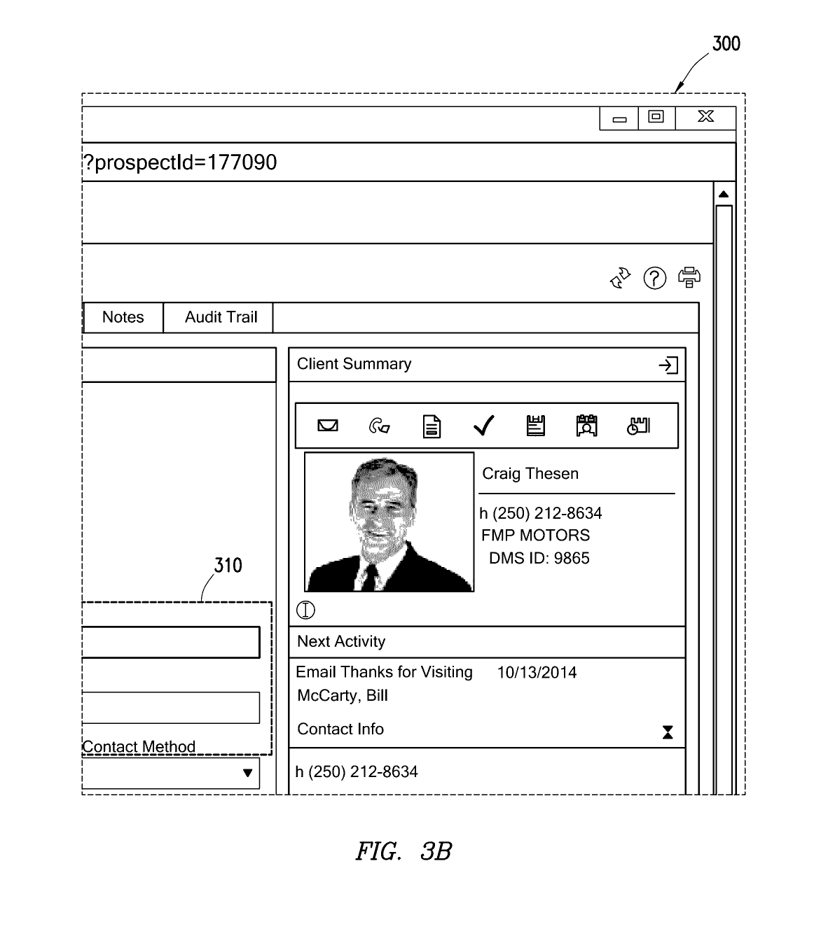

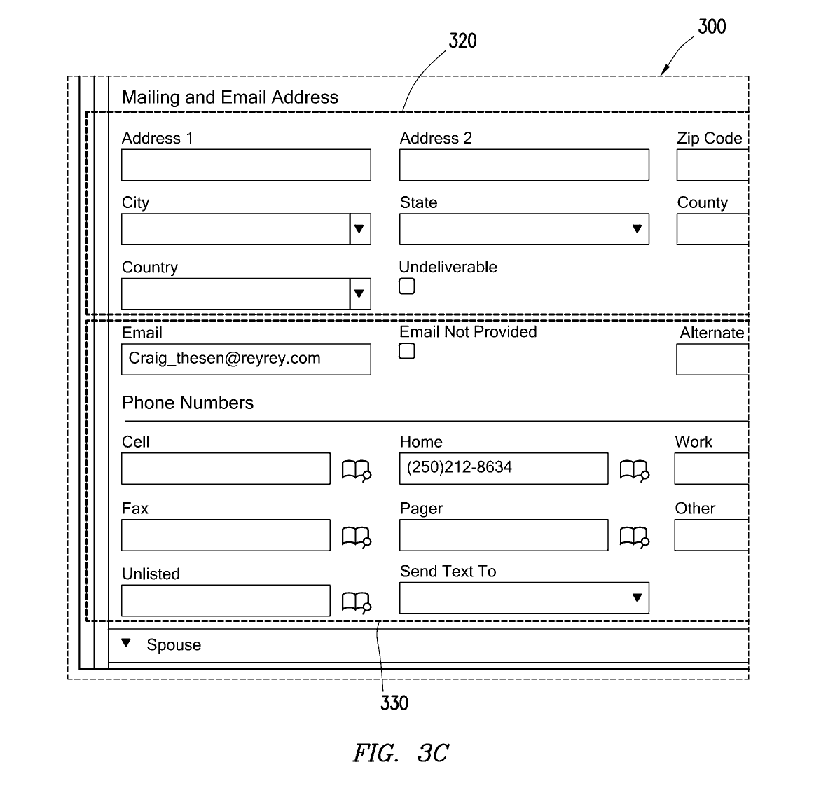

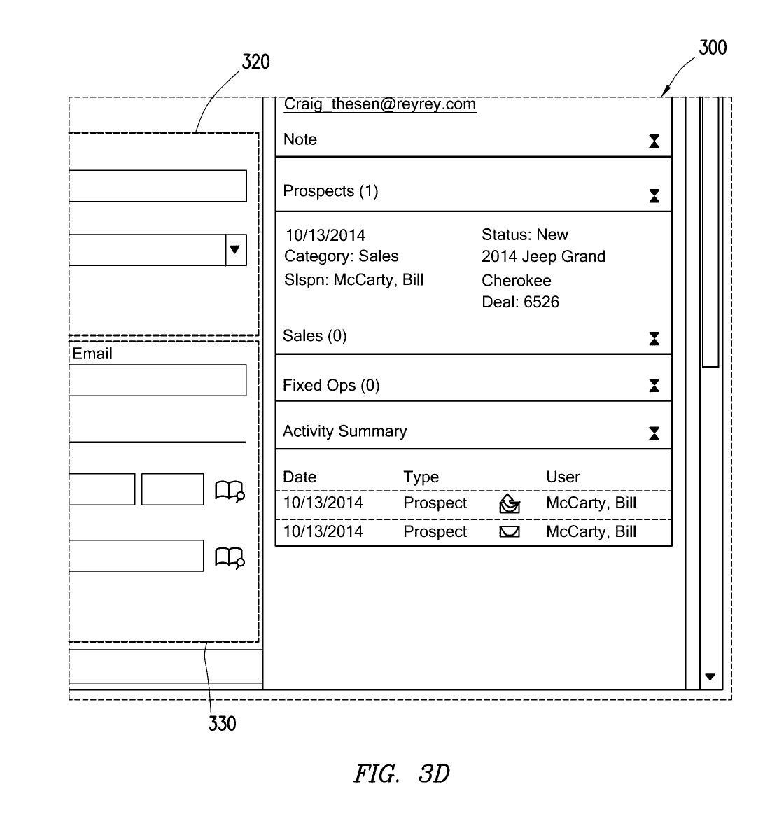

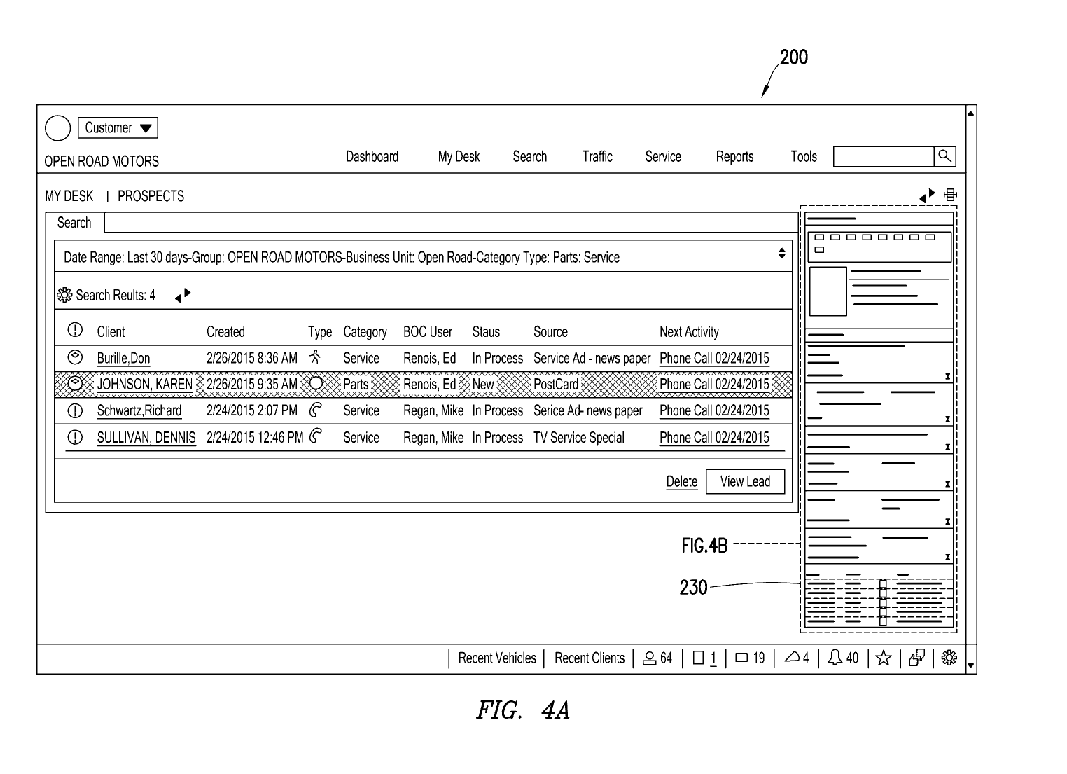

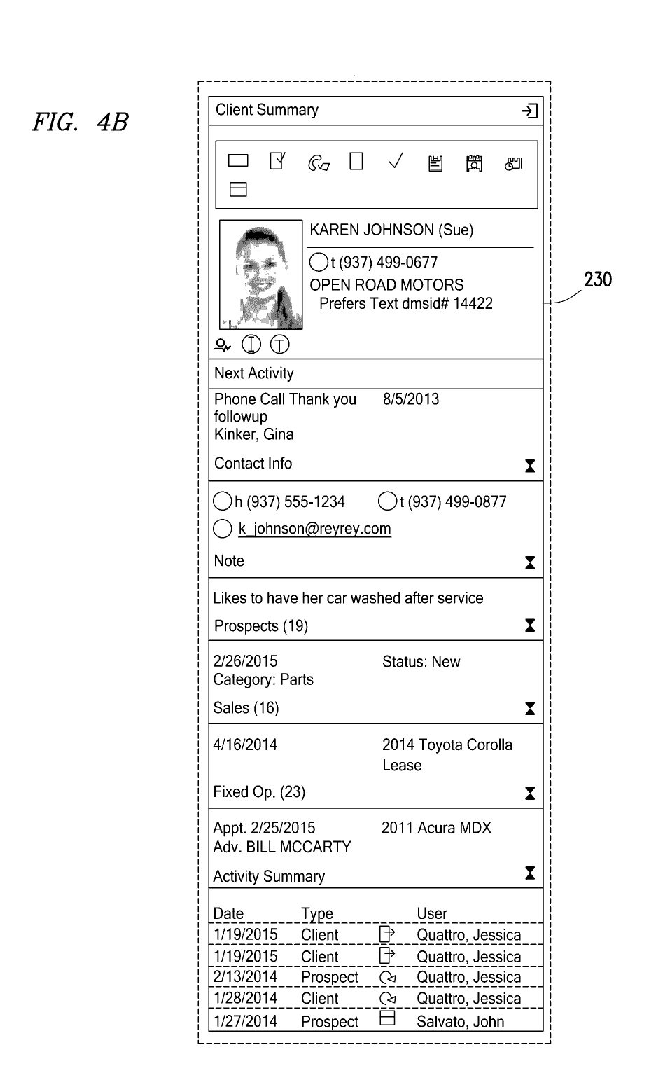

In some embodiments, the prospect information reflected in my desk prospects GUI 200 may be transmitted into a computer system by a variety of methods. For instance, in some embodiments, as shown in FIGS. 3A-D, information regarding the existing client may be entered through existing client profile GUI 300. As shown in existing client profile GUI 300, existing client information, including, for example and without limitation, the existing client's name 310, existing client's address 320 and existing client contact information 330 may be entered by a user or may be drawn from existing databases. In some embodiments, a summary of information (“client profile”) entered through existing client profile GUI 300 may be available in my desk prospects GUI 200 as depicted in FIGS. 4A and 4B. In some embodiments, a user may interact with my desk prospects GUI 200 in order to display the existing client profile. For example and without limitation, utilizing an interaction device such as a mouse, the user may interact with a button or other interactive feature. In some embodiments, by indicating a “client”, my Desk Prospects GUI 200 may be modified to display inset 230. Inset 230 may, in some embodiments, include some or all of the existing client information available in the existing client profile. In certain embodiments, the step of assign prospect 110 may further include checking the information about the existing client to determine if the existing client profile is a duplicate client entry, i.e., an existing client profile that duplicates part or all of another client profile, and may take appropriate action, such as modifying or deleting the second or other client profile. Determining if the existing client is a duplicate client entry may be accomplished by the employee to which the prospect is assigned or by a computer, wherein the computer compares existing client information to determine if existing client information duplicates another existing client profile. Existing client information may be stored in non-transitory, tangible computer readable storage medium

As further depicted in FIG. 2, in some embodiments, my desk prospects GUI 200 may provide a user the ability to filter assigned prospects on a number of filterable criteria and display only those prospects that fit the filterable criteria, i.e., the prospects are selectively displayable by the user. Filterable criteria may include, for example and without limitation, date, group, business unit, relationship type, status type, category type and user. One of skill in the art with the benefit of this disclosure would recognize other filterable criteria. In certain embodiments, particular users may be prevented by my desk prospects GUI 200 from filtering using certain filterable criteria. For instance, as shown in FIG. 2, particular users may be prevented from displaying other user prospects by filtering using the user filterable criteria.

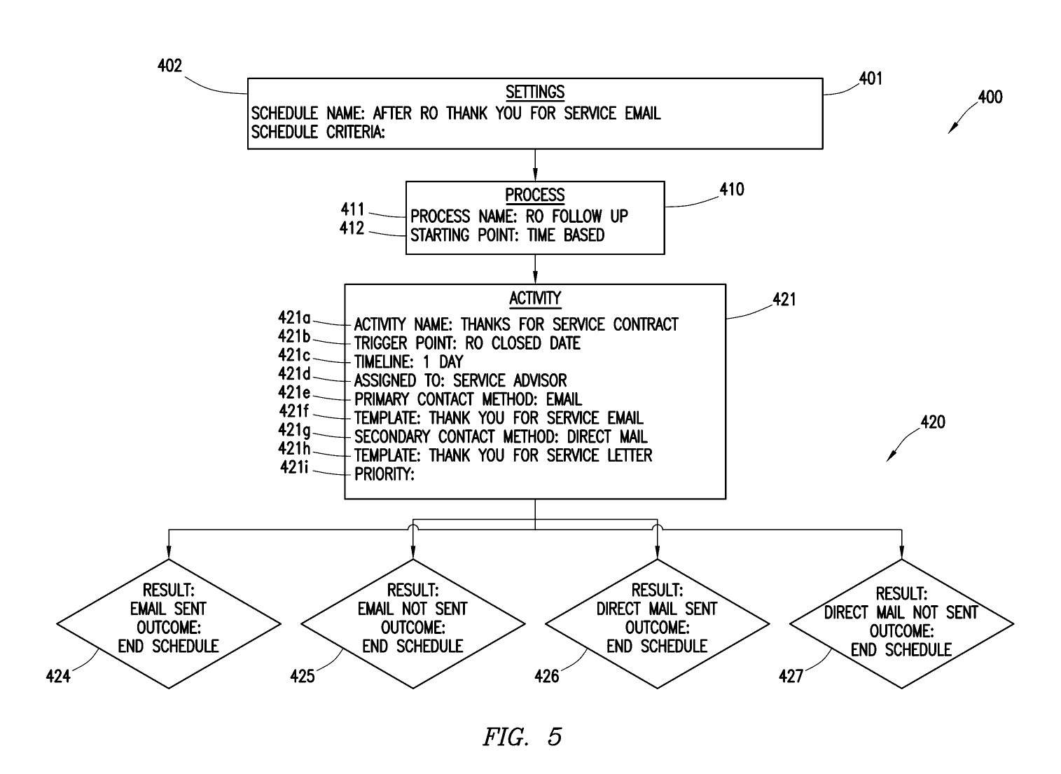

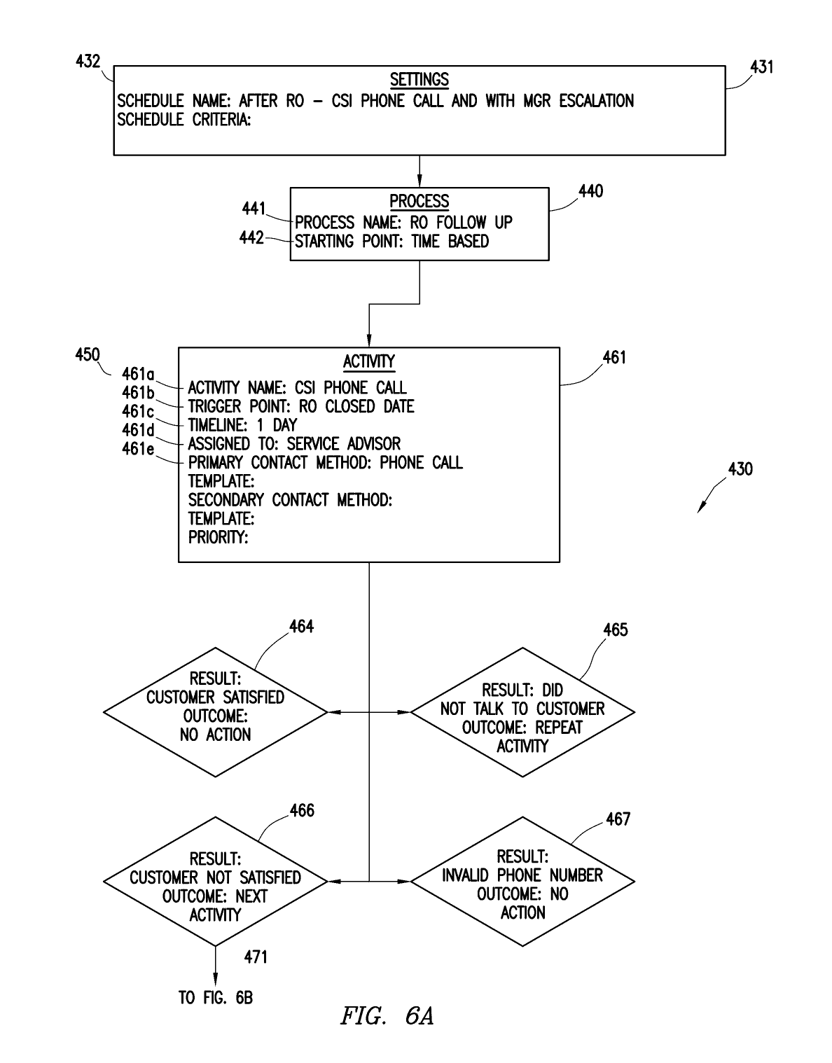

Once the prospect has been assigned in assign prospect 110, a follow-up activity may be created in generate follow-up activity 120. A follow-up activity is an activity generated by a computer algorithm that is assigned to the dealership employee to which the prospect was assigned in assign prospect 110 or to another dealership employee. In certain embodiments of the present disclosure, the follow-up activity may be determined by computer algorithm based on one or more results-based schedules. As used herein, a results-based schedule is a schedule in which at least one follow-up activity is determined based at least in part on the results of an interaction between the dealership and/or its employees and the existing client. The results-based schedules may be stored in a non-transitory, tangible computer readable storage medium. A follow-up activity may include, for instance and without limitation, an email, text, or transmission of the recorded voice of a dealership employee, or direct mail to an existing client, or a telephone call to an existing client. Also as used herein, a time-based schedule is a schedule in which the all follow-up activities are determined only by the passage of time after an interaction between the dealership and/or its employees and the existing client. Use of results-based schedules may allow, for example and without limitation, dealership personnel, such as a sales person or service employee, to select or assign an appropriate next action to take with the existing client based on certain results. In some embodiments, the next action may be triggered depending on one or more results. The differences between a results-based schedule and a time-based schedule are illustrated in FIGS. 5, 6, 7, and 8.

Based on the results-based schedule, one or more follow-up activities may be determined by a computer in assign-follow-up activity 130 as shown in FIG. 1. The follow-up activities may thereafter be assigned to a dealership employee by a computer algorithm or another dealership employee. A dealership employee may then take the action dictated by the results-based schedule in action 140, as shown in FIG. 1. The action taken by the dealership employee may be stored in a non-transitory, tangible computer readable storage medium.

FIG. 5 is a flow chart of a time-based schedule for a service prospect associated with an existing client. FIG. 5 depicts thank you for service—time based flow chart 400. In service—time based flow chart 400, activities by the user do not prompt the user to conduct additional activities.

Service—time based flow chart 400 includes settings block 401, process block 410, and flow chart blocks 420. Settings block 401 includes schedule name 402, which, as shown in FIG. 5, is “After RO Thank You for Service Email.”

FIG. 5 further includes process block 410. Process block 410 includes process name 411. Process name 411 is the name of the time-based schedule, which for FIG. 5 is “RO Follow Up.” Process block 410 further includes starting point 412. Starting point 412 specifies at what point the time-based schedule in FIG. 5 will start. As shown in FIG. 5, starting point 412 is time-based.

Flow chart blocks 420, as shown in FIG. 5, include activity block 421 and result blocks 424, 425, 426, and 427. Activity block 421 includes activities performed by the user as part of service—time based flow chart 400. Activity block 421 includes activity name 421a. Activity name 421a is the name of the activity performed in activity block 421. Activity name 421a in block 421 is “Thanks for Service Contact.” Activity block 421 further includes trigger point 421b. Trigger point 421b describes the event that actuates the activity block. Trigger point 421b is “RO Closed Date.” Activity block 421 further includes timeline 421c. Timeline 421c defines the time between when trigger point 421b is actuated and when the activity prescribed in activity block 421 is performed. Timeline 421c is one day. Activity block 421 also includes assigned to 421d. Assigned to 421d is “Service Advisor.” Activity block 421 further includes primary contact 421e. Primary contact 421e specifies the primary contact method with the existing client for the activity of the activity block. Examples of primary contact 421e may include, but are not limited to, telephone, email, text, transmission of a recorded voice of a dealership employee, direct mail, or in person communication. Primary contact 421e in activity block 421 is “Email.” Activity block 421 also includes template 421f corresponding to primary contact 421e. Template 421e specifies the template for the communication for the primary contact method of communication with the client. Template 421f in activity block 421 is “Thank You for Service Email.” Activity block 421 additionally includes secondary contact method 421g. Secondary contact 421g specifies a secondary contact method with the client for the activity of the activity block in the event that the primary contact method is not available or undesirable. Examples of secondary contact 421g may include, but are not limited to, telephone, email, text, transmission of a recorded voice of a dealership employee, direct mail, or in person communication. Activity block 421 also includes secondary template 421h, labelled “Template” in FIG. 5. Secondary template 421h specifies the secondary template for the communication for the secondary contact method of communication with the existing client. Secondary template 421h in activity block 421 is “Thank You for Service Letter.” Template 421e and secondary template 421h may be fillable documents such as emails or online documents customizable by the user for the prospect and/or client. In certain embodiments of the present disclosure, template 421e and secondary template 421h may be stored in a database accessible to the user. Activity block 421 also includes priority 421i. In certain embodiments, multiple follow-up activities may be targeted at a client. In these embodiments, a computer-run rules engine may designate that a client may receive only a certain number of communications in a given time period. Which communications are sent to a client may depend in part on the priority assigned to the communication. Priority 421i may designate the priority of a communication resulting from a particular activity. An embodiment of implementing priority of communications is discussed hereinbelow.

Flow chart blocks 420 include result blocks 424, 425, 426, and 427, which are result blocks from activity block 421. As shown in FIG. 5, regardless of whether email is sent (result block 424) or not sent (result block 425) or if direct mail is sent (result block 426) or not sent (result block 427), the schedule terminates, i.e., there is no activity that depends upon the outcome of result blocks 424, 425, 526, or 427.

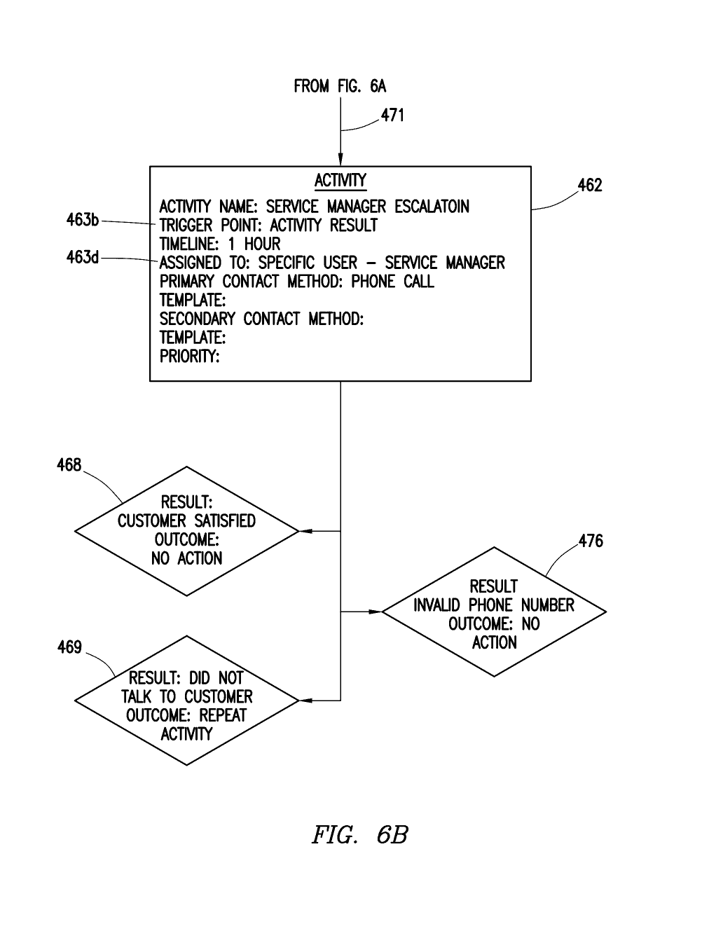

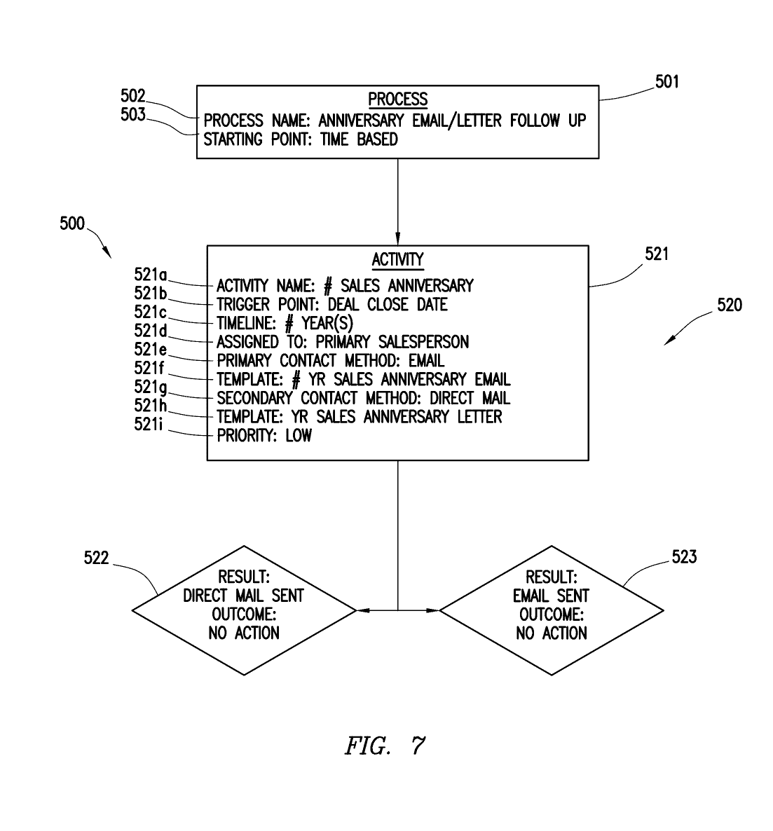

FIGS. 6A and 6B is a flow chart of a results-based schedule consistent with at least one embodiment of the present disclosure. FIGS. 6A and 6B depict RO followup—results based flow chart 430.

RO followup—results based flow chart 430 includes settings block 431, process block 440, and flow chart blocks 450. Settings block 431 includes schedule name 432, which, as shown in FIGS. 6A and 6B, is “After RO—CSI Phone Call and with Mgr Escalation.”

FIGS. 6A and 6B further includes process block 440. Process block 440 includes process name 441. Process name 441 is the name of the results-based schedule, which for FIGS. 6A and 6B is “RO Follow Up.” Process block 440 further includes starting point 442. Starting point 442 specifies at what point the results-based schedule in FIGS. 6A and 6B will start. In certain embodiments, such as that shown in FIGS. 6A and 6B, starting point 442 is time-based. Results-based schedules having time-based starting points begin at a predetermined time, such as immediately, or after a delay, such as a set number of days or weeks (as shown in FIGS. 6A and 6B). Other starting points may be results-based, i.e., the results-based schedule starting point may depend upon the completion of an activity from a different results-based or time-based schedule.

Flow chart blocks 450, as shown in FIGS. 6A and 6B, include activity blocks 461 and 462, and result blocks 464, 465, 466, 467, 468, 469, and 470. Activity blocks 461, and 462 include activities performed by the user as part of RO followup—results based flow chart 430. As an example, activity block 461 includes activity name 461a. Activity name 461a is “CSI Phone Call.” Activity block 461 further includes trigger point 461b. Trigger point 461b is “RO Closed Date.” Activity block 461 further includes timeline 461c. Timeline 461c is one day. Activity block 461 also includes assigned to 461d. Assigned to 461d is “service advisor.” Activity block 461 further includes primary contact 461e. Primary contact 461e in activity block 461 is “Phone Call.”

Flow chart block 430 include result blocks 464, 465, 466, and 467, which are result blocks from activity block 461. As shown in FIGS. 6A and 6B, if phone call to the existing client results in a customer satisfied (result block 464), or if the phone call results in an invalid number, no further action is taken (result block 825) by the user. If the phone call to the existing client results in a did-not-talk-to-customer results-based outcome, activity block 461 is repeated. If the phone call by the user results in a customer-not-satisfied results-based outcome, the user is prompted to begin the results-based activity in activity block 462, i.e., “Service Manager Escalation” through unsatisfied customer results-based outcome 471. Activity block 462 is a non-limiting example of a client care issue discussed hereinbelow.

As further shown in FIGS. 6A and 6B, activity block 462 includes trigger point 463b. Trigger point 463b is “activity result,” i.e., the trigger point is based on a results-based activity, which, with respect to FIGS. 6A and 6B, is whether result block 461 resulted in a customer-not satisfied outcome. Further, as shown in FIGS. 6A and 6B, assigned to 463d is “service manager.” Thus, if the existing client was not satisfied with the service, the results-based activity result is that the sales manager is assigned the activity in activity block 462.

With further direction to FIGS. 6A and 6B, with respect to activity block 462, if the phone call to the customer indicates that the customer is satisfied (result block 468) or the phone number is invalid (result block 470) no further action is taken. If the phone call by the service manager to the customer results in a did-not-talk-to customer outcome (result block 469), the phone call in activity block 462 is repeated.

FIG. 7 is a flow chart example of time-based schedule for a sales prospect. FIG. 7 depicts thank you for anniversary email/direct mail flow chart 500. In thank you for anniversary email/direct mail flow chart 500, activities by the user do not prompt the user to conduct additional activities.

Thank you for anniversary email/direct mail flow chart 500 includes process block 501, and flow chart blocks 520. Process block 501 includes process name 502. Process name 502 is the name of the time-based schedule, which for FIG. 7 is “Anniversary Email/Letter Follow Up.” Process block 501 further includes starting point 503. Starting point 503 specifies at what point the time-based schedule in FIG. 7 will start. As shown in FIG. 7, starting point 503 is time-based.

Flow chart blocks 520, as shown in FIG. 7, include activity block 521 and result blocks 522 and 523. Activity block 521 includes activities performed by the user as part of thank you for anniversary email/direct mail flow chart 500. Activity block 521 includes activity name 521a. Activity name 521a in block 521 is “# Sales Anniversary.” “#” refers to the yearly anniversary of the deal close date, i.e., activity block activity block 521 may be repeated on the anniversary of the deal close date for a set number of years. Activity block 521 further includes trigger point 521b. Trigger point 521b is “After-Deal Close Date.” Activity block 521 further includes timeline 521c. Timeline 521c is # years(s). Activity block 521 also includes assigned to 521d. Assigned to 521d is “Primary Sales Person.” “Primary Salesperson” refers to the salesperson determined by the dealership to have been the salesperson responsible for the sale or lease of the vehicle to the existing client, or the salesperson to which the existing client has been assigned. Activity block 521 further includes primary contact 521e. Primary contact 521e in activity block 521 is “Email.” Activity block 521 also includes template 521f corresponding to primary contact 521e. Template 521f in activity block 521 is “# Yr Sales Anniversary Email.” Activity block 521 additionally includes secondary contact method 521g. Activity block 521 also includes secondary template 521h, labelled “Template” in FIG. 7. Secondary template 521h in activity block 521 is ““# Yr Sales Anniversary Letter.” Priority 521i may designate the priority of a communication resulting from a particular activity. An embodiment of implementing priority of communications is discussed hereinbelow. In activity block 521, priority 521i is “low.”

Flow chart blocks 520 include result blocks 522 and 523, which are result blocks from activity block 521. As shown in FIG. 7, once the email is sent (result block 523) or the direct mail is sent (result block 522), the schedule terminates, i.e., there is no activity that depends upon the outcome of result blocks 522 and 523.

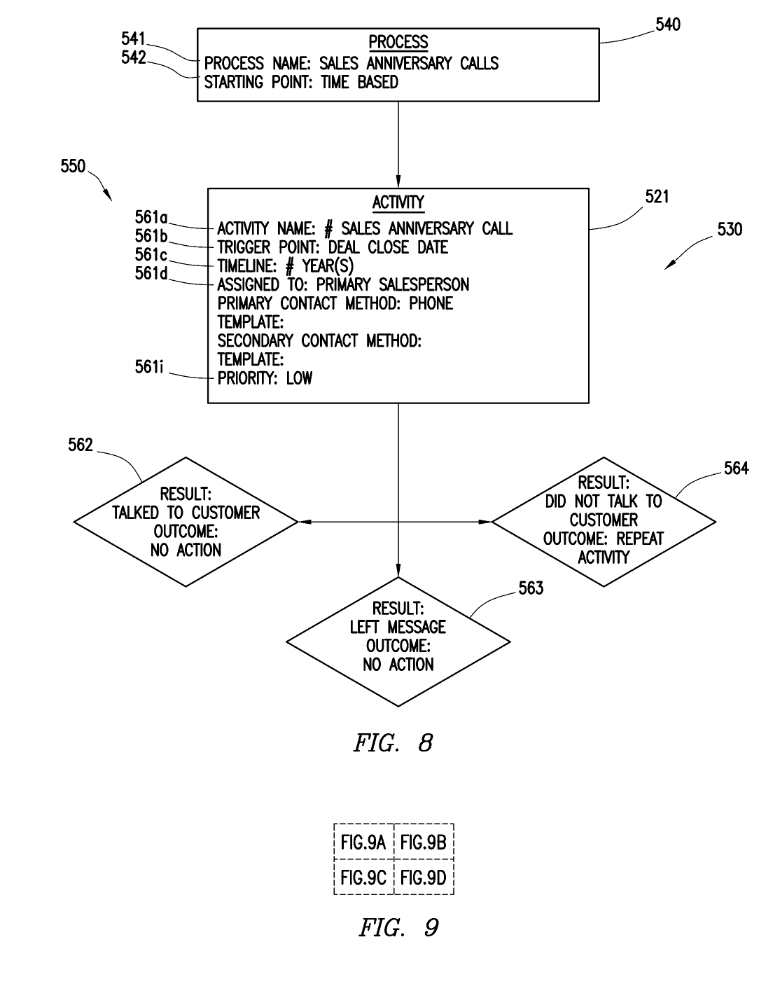

FIG. 8 is a flow chart of a results-based schedule associated with a sales prospect consistent with at least one embodiment of the present disclosure. FIG. 8 depicts sales anniversary—results based flow chart 530.

Sales anniversary—results based flow chart 530 includes process block 540, and flow chart blocks 550. Process block 540 includes process name 541. Process name 541 is the name of the results-based schedule, which for FIG. 8 is “Sales Anniversary Phone Call.” Process block 540 further includes starting point 542. Starting point 542 specifies at what point the results-based schedule in FIG. 8 will start. In certain embodiments, such as that shown in FIG. 8, starting point 542 is time-based.

Flow chart blocks 550, as shown in FIG. 8, include activity block 561 and result blocks 562, 563, and 564. Activity block 561 includes the activity performed by the user as part of sales anniversary—results based flow chart 530. Activity block 561 includes activity name 561a. Activity name 561a is “# Sales Anniversary Call.” Activity block 561 further includes trigger point 561b. Trigger point 561b is “After-Deal Close Date.” Activity block 561 further includes timeline 561c. Timeline 561c is “# Years(s).” Activity block 561 also includes assigned to 561d. Assigned to 561d is “Primary Salesperson.” Activity block 561 further includes primary contact 561e. Primary contact 461e in activity block 561 is “Phone.” In addition, activity block 561 includes priority 561i. Priority 561i is “low.”

Flow chart block 530 include result blocks 562, 563, and 564, which are result blocks from activity block 561. As shown in FIG. 8, if phone call to the existing client results in contact with the customer (result block 562), or if the phone call results in a message left on a customer's voicemail, no further action is taken by the user. If the phone call to the existing client results in a did-not-talk-to-customer results-based outcome (result block 564), activity block 561 is repeated.

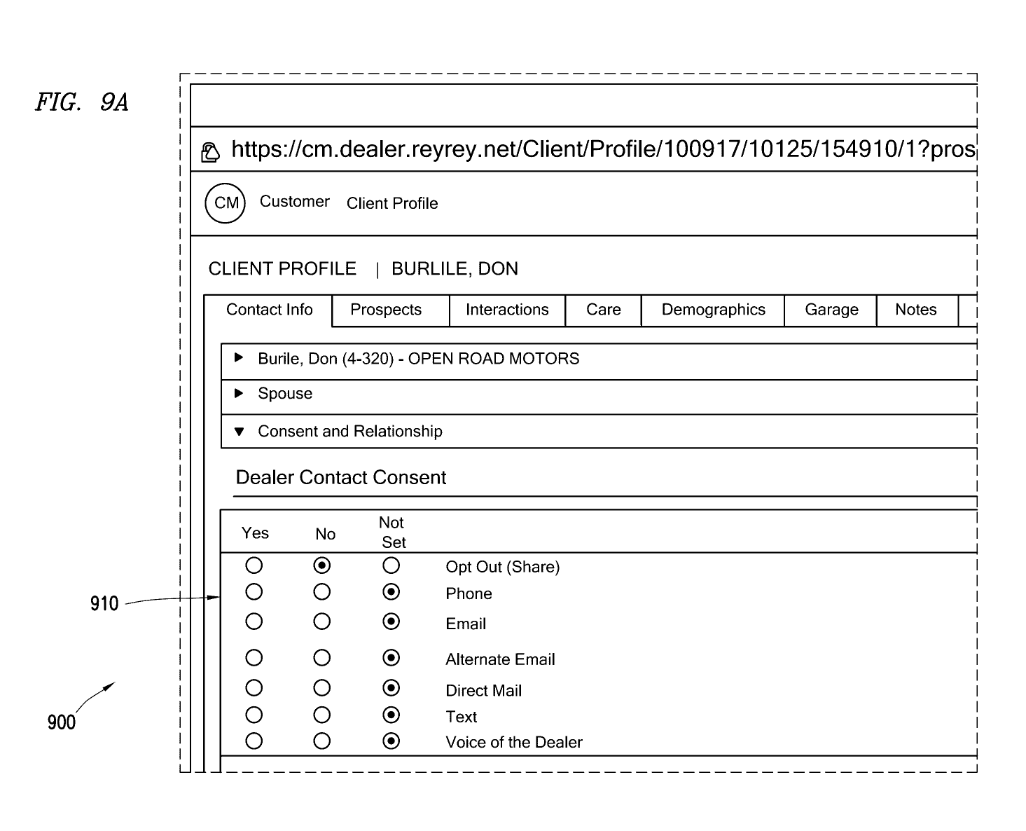

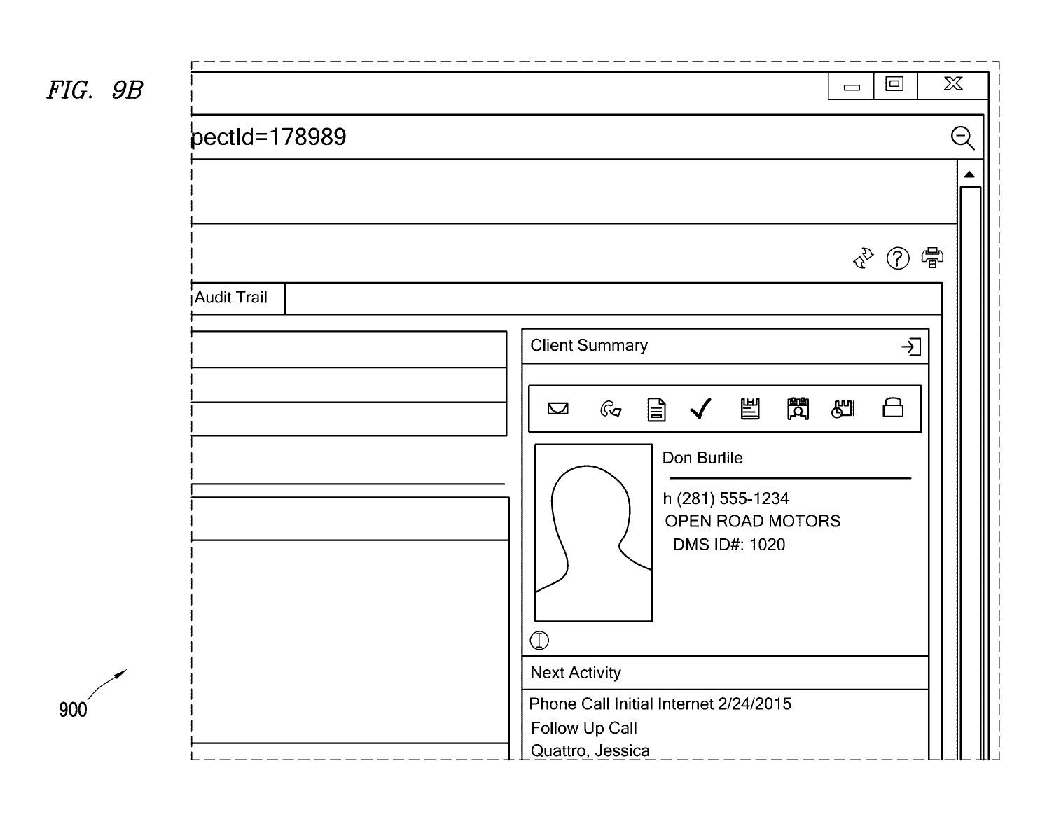

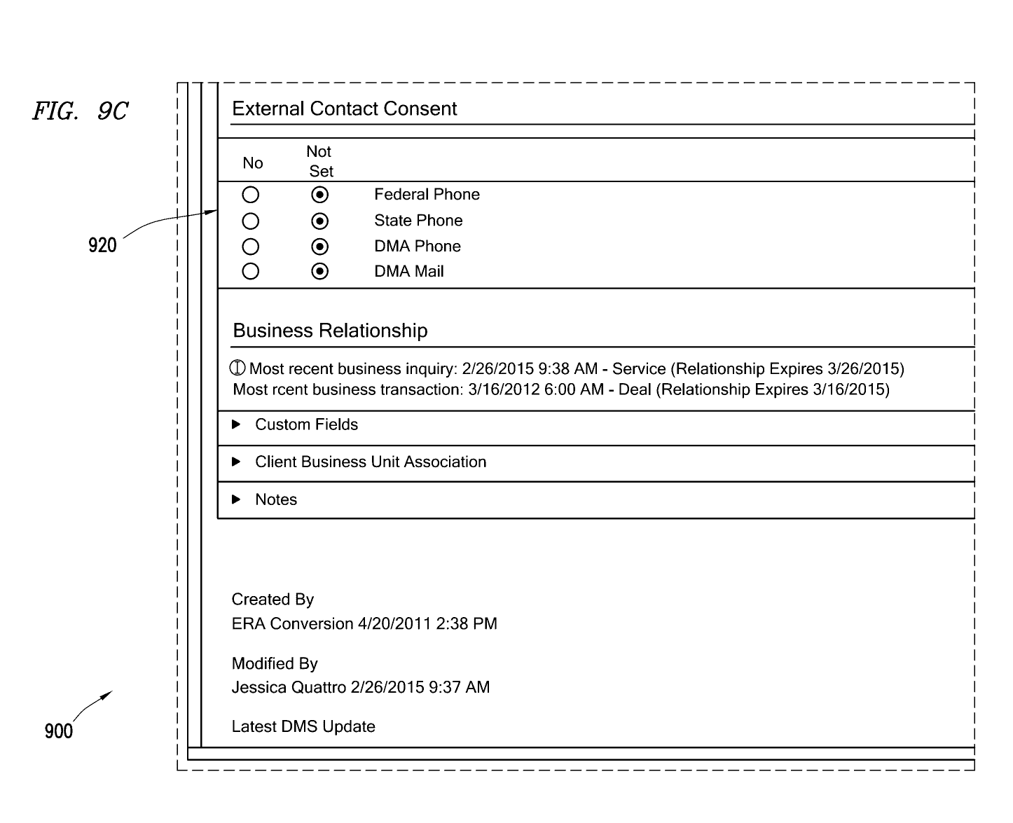

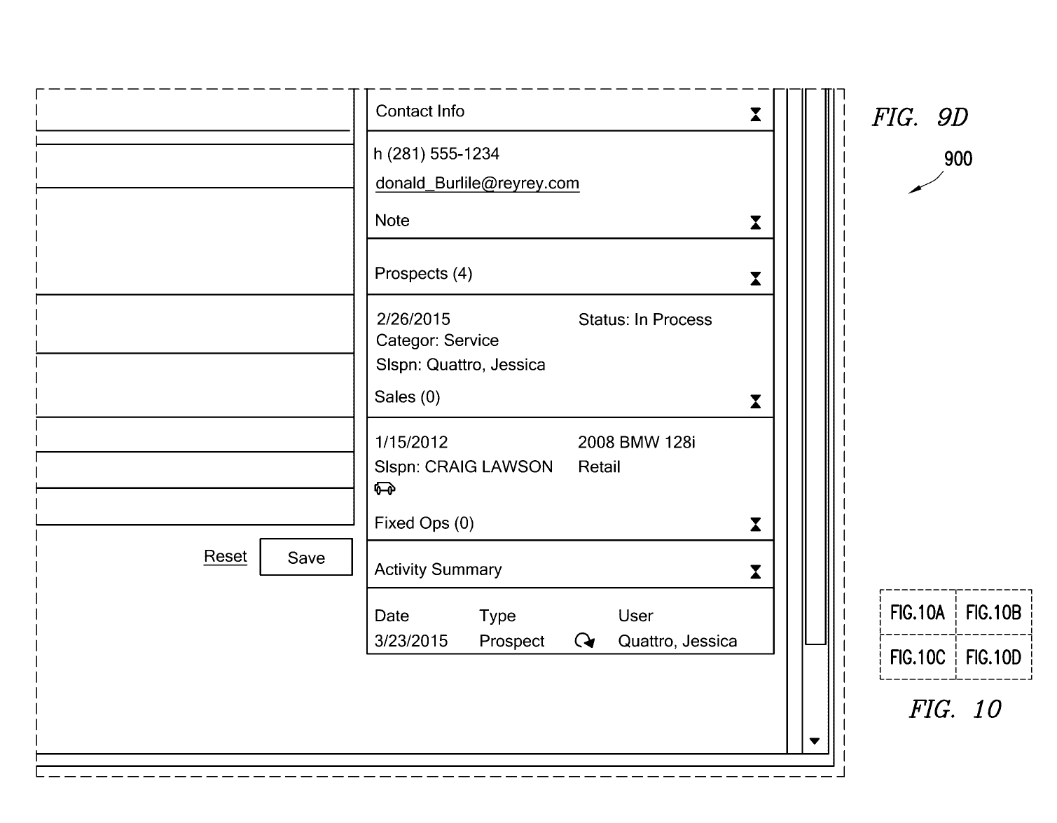

In certain embodiments of the present disclosure, client privacy preferences may be identified for each client. For instance, privacy preferences such as Federal and State Do Not Call flags and contact consent for e-mail, mail and third party data sharing may be identified or tracked for a client. Based on the identified privacy preferences, the results-based schedules may be modified. For existing clients, the results-based schedules in generate follow-up activity 120 may then modify the follow-up activity based on client preference. In some embodiments, as depicted in FIGS. 9A-9D, customer contact GUI 900 allows dealership employees to set a client's restrictions regarding contact by dealership employees, such as agreeing or not agreeing to phone, e-mail, direct mail, text or voicemail from the dealer, as shown in direct contact consent settings 910. Customer contact GUI further allows Federal and State Do Not Call Flags to be set, as shown in external contact consent settings 920

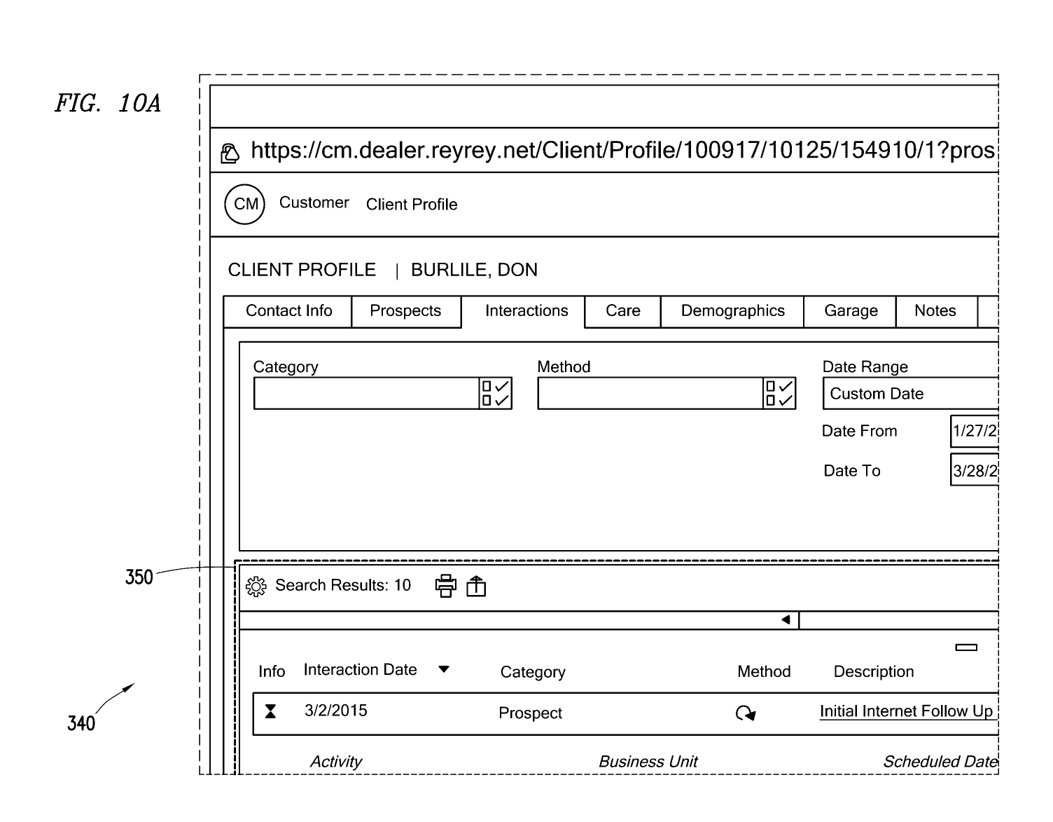

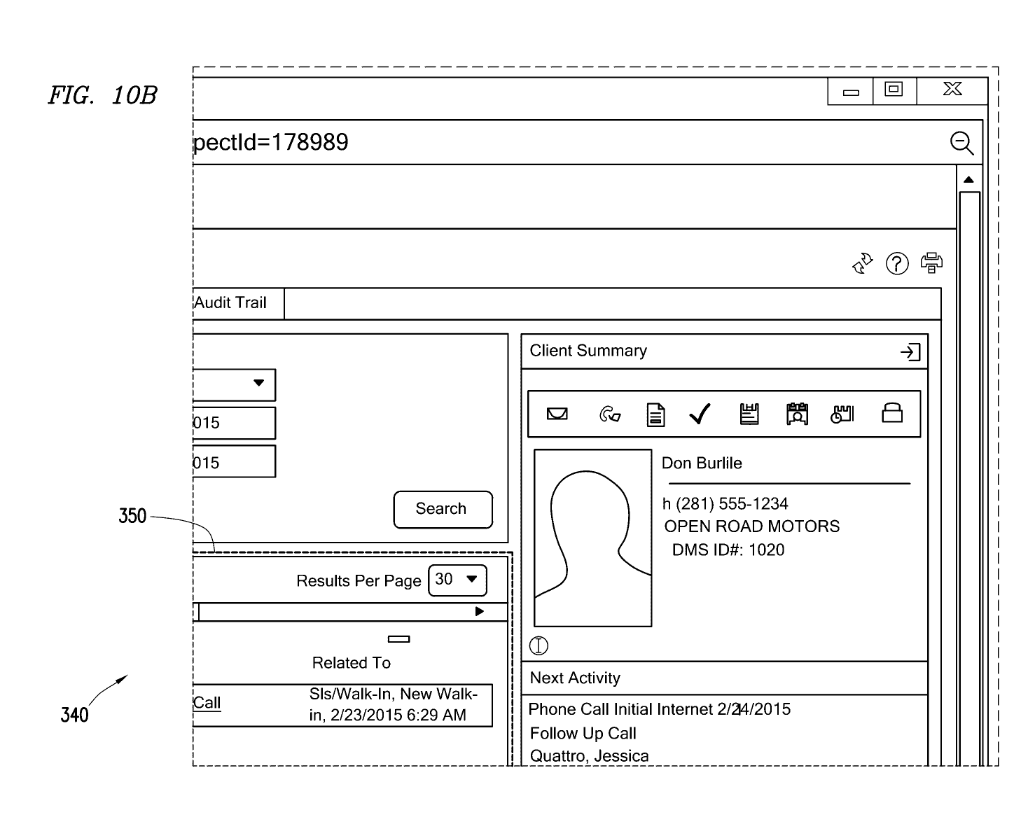

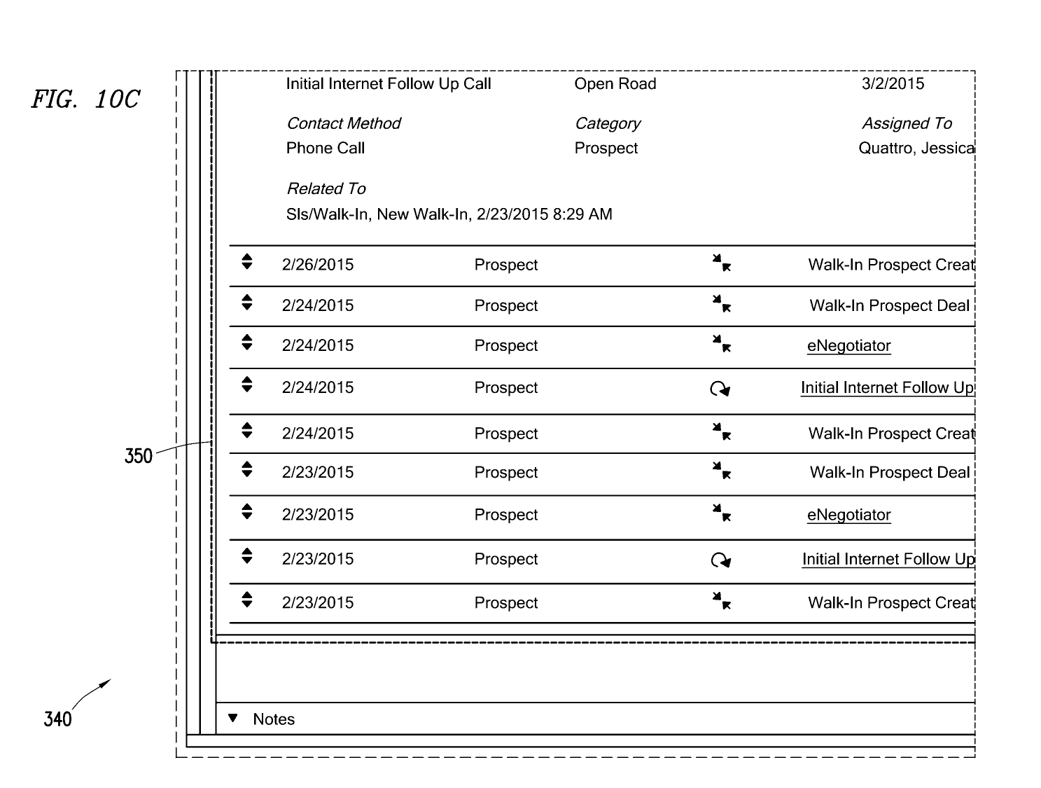

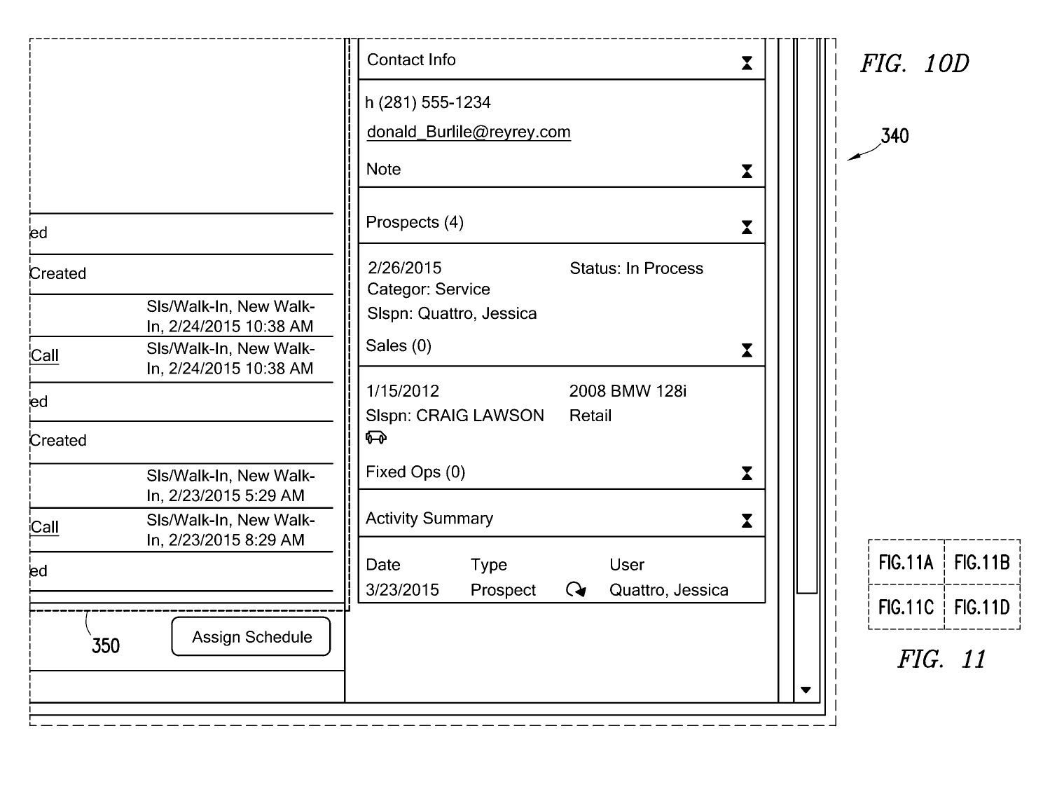

In certain embodiments, such as for existing clients as part of action 140, all interactions with a client may be logged. A log may, for instance, be included as part of the client profile. As shown FIGS. 10A-10D, client profile interactions GUI 340 may display interaction 350 description, which may include such non-limiting information as the interaction date, the category of the client, the method used in the interaction and the description of the interaction for an existing client.

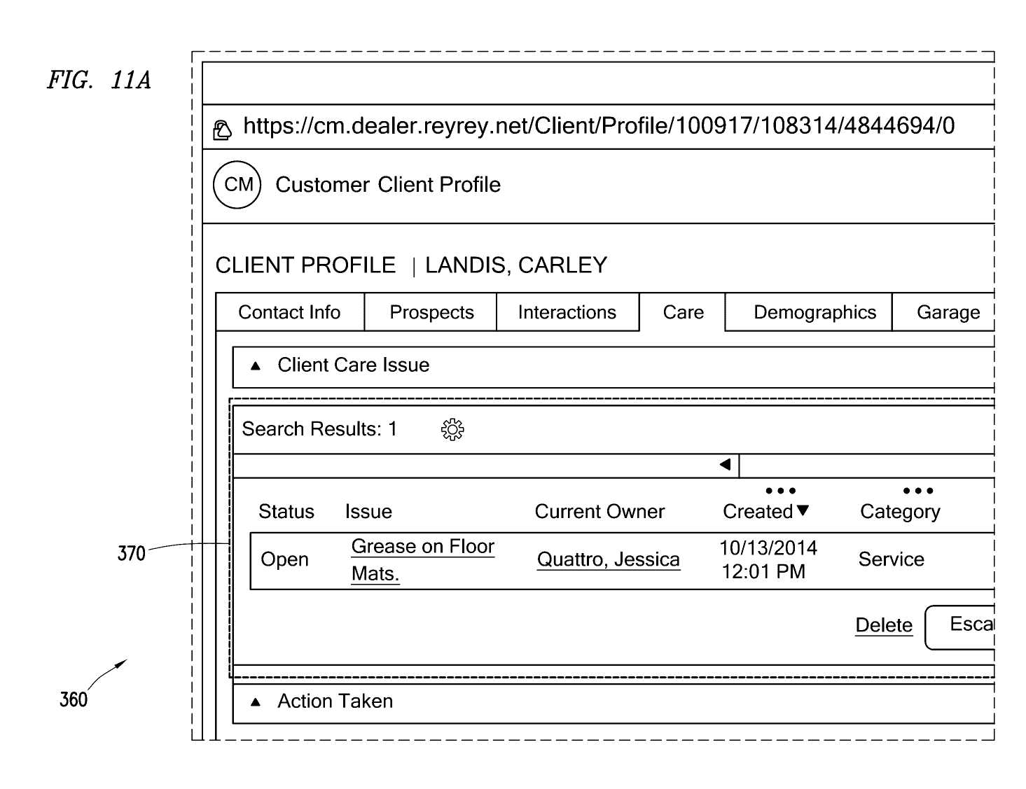

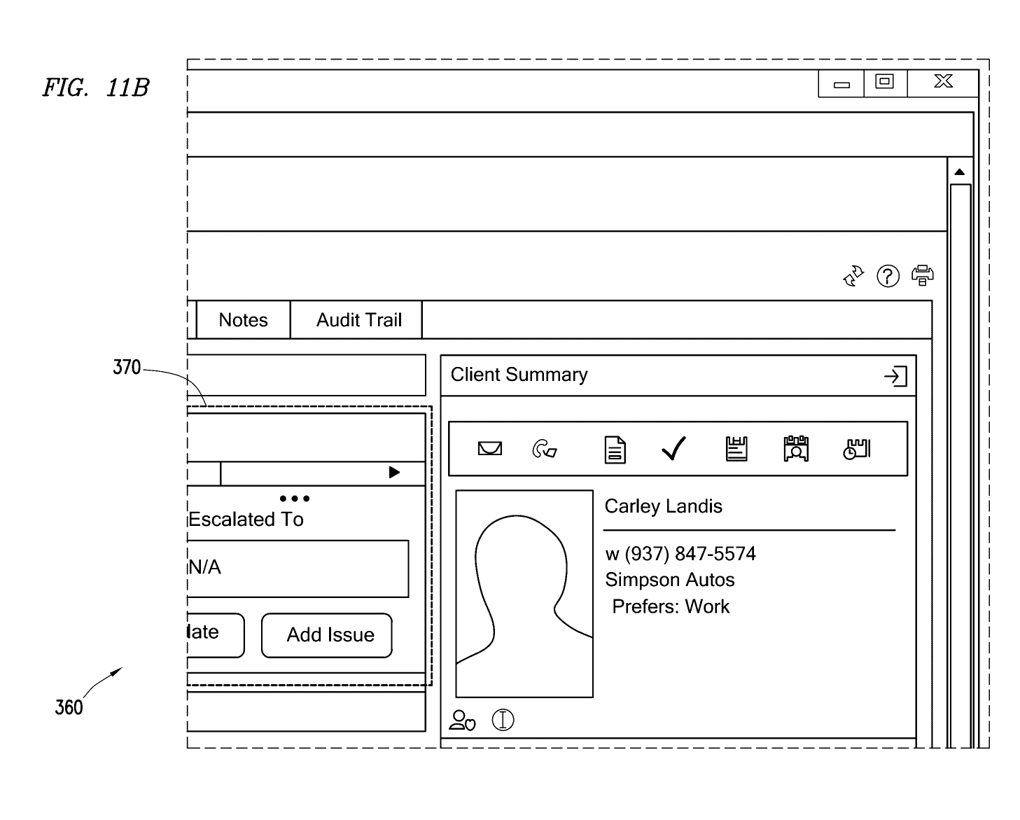

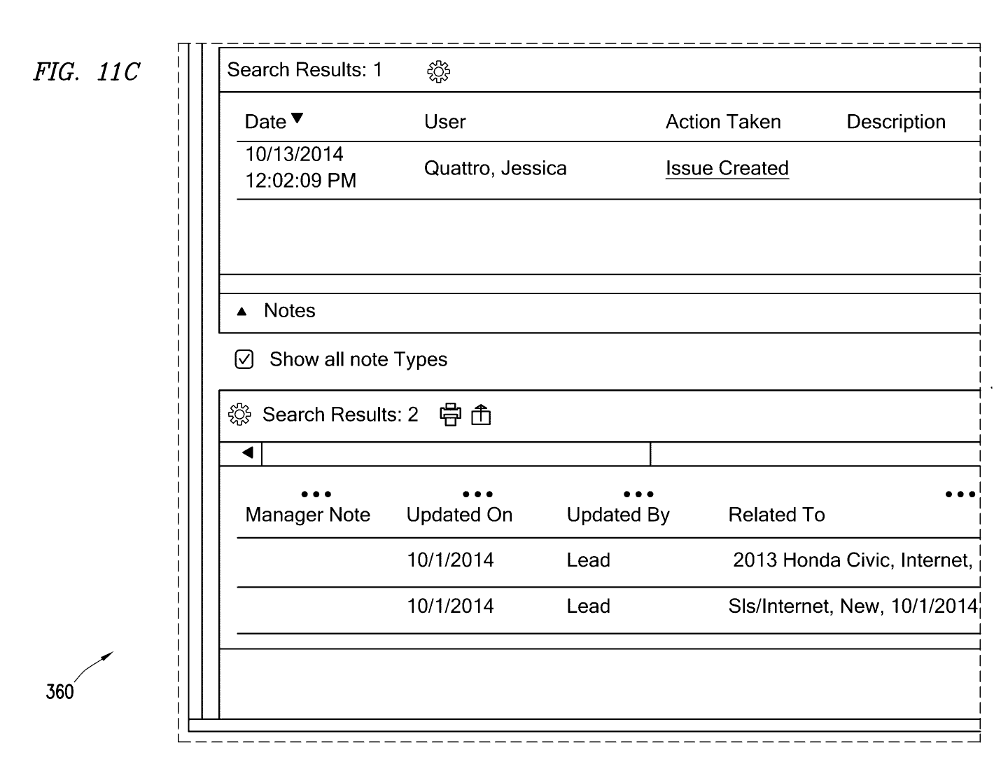

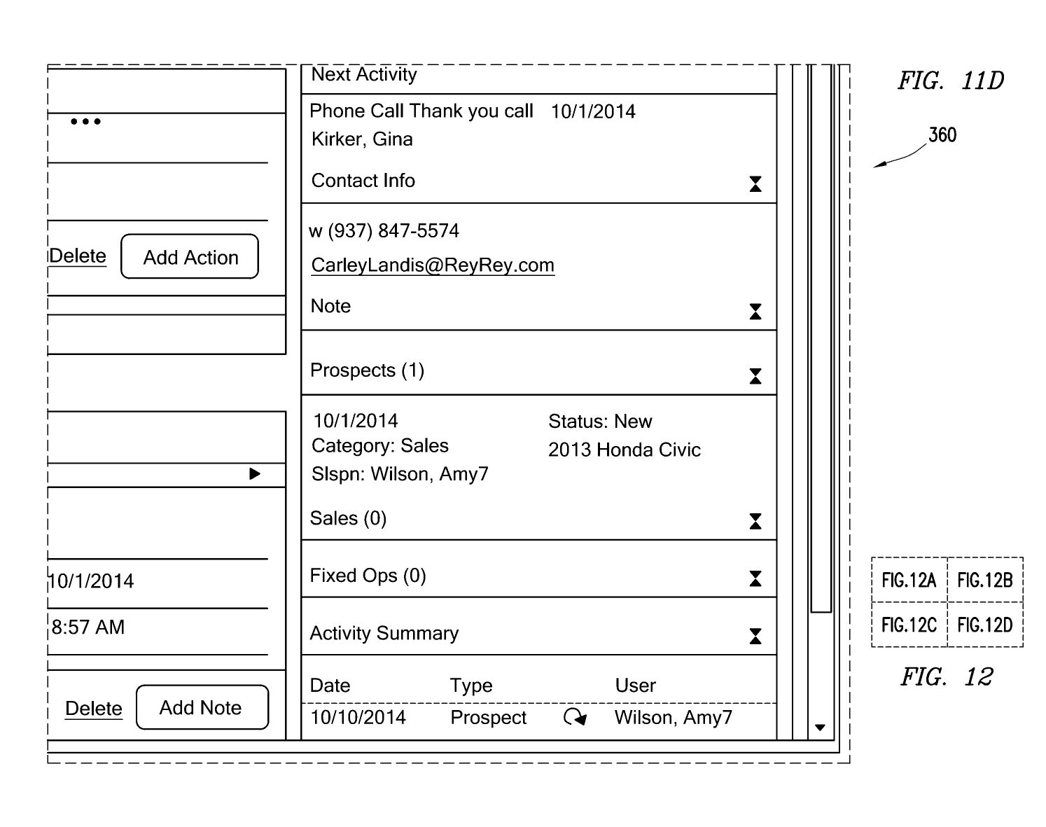

Generate follow-up activity 120 may be customized for particular existing clients based, for example, on interactions with an existing client. For instance, a negative interaction between an existing client and the dealership or one of its employees, may generate a client care issue that may be logged and displayed as part of the existing client profile. In some embodiments, as shown in FIGS. 11A-11D, existing client profile client care GUI 360 may be utilized to display such information. Existing client profile client care GUI 360 may include an existing client care description 370 of the interaction between the existing client and the dealership or one of its employees. Existing client care description 370 may include such information as the status, the issue, the current owner of the follow-up activity, when the incident occurred or was entered into existing client profile client care GUI 360 and other information related to the interaction.

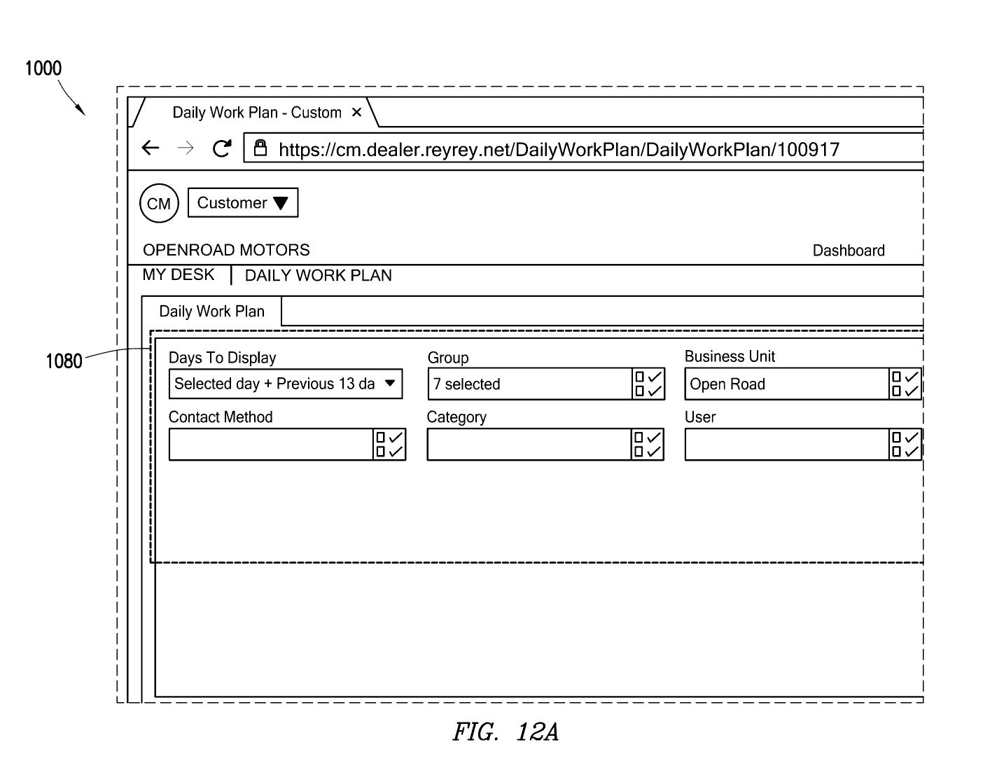

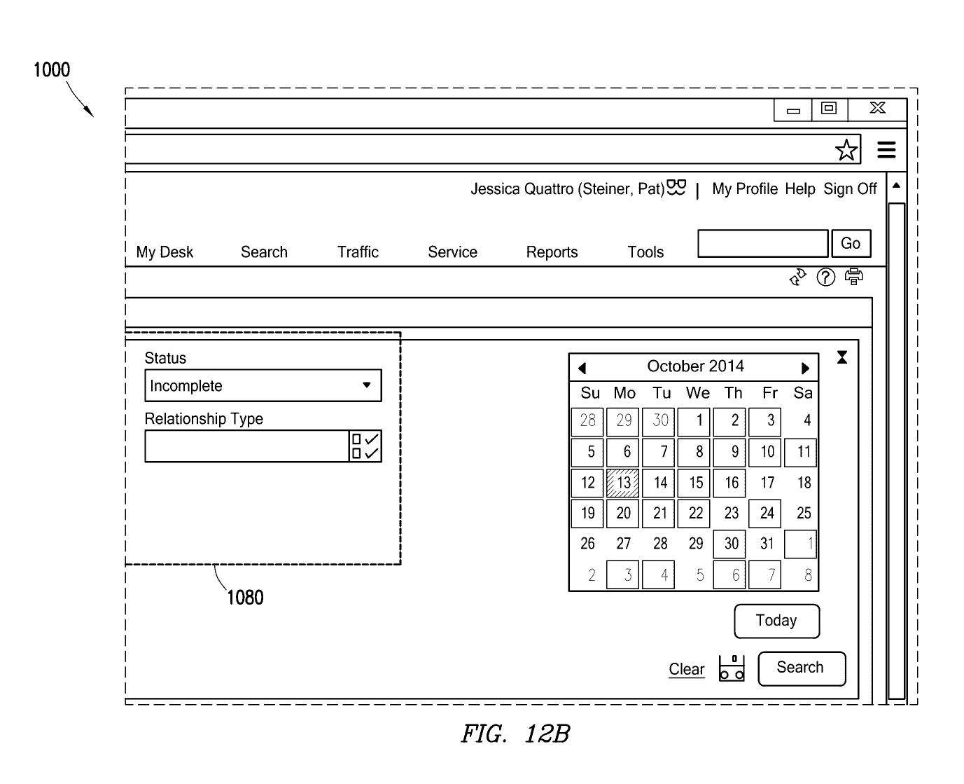

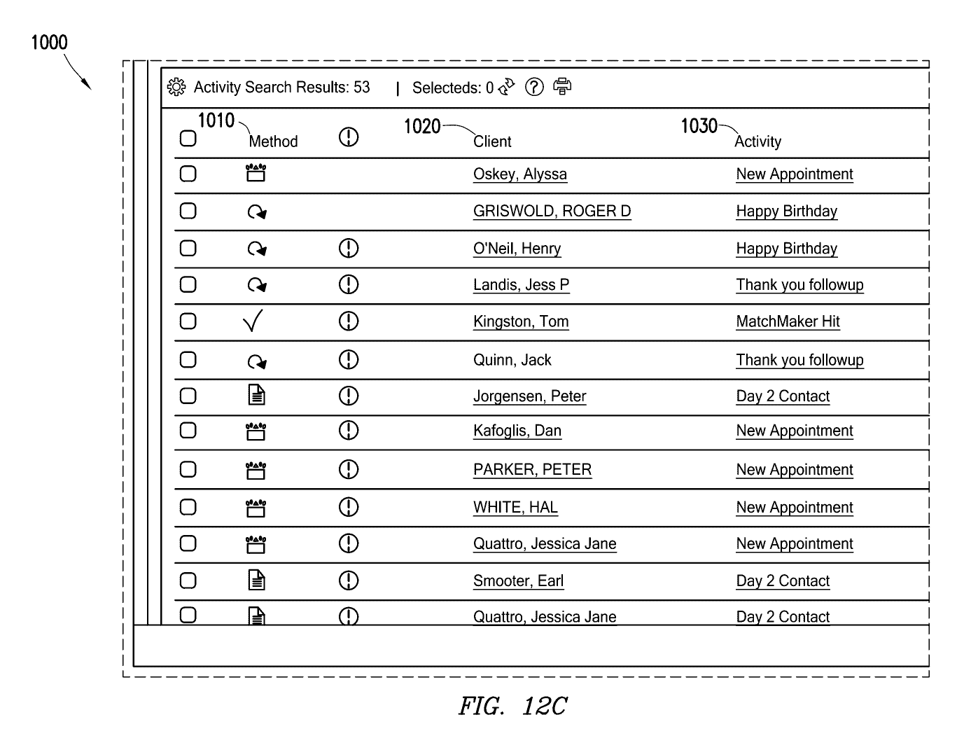

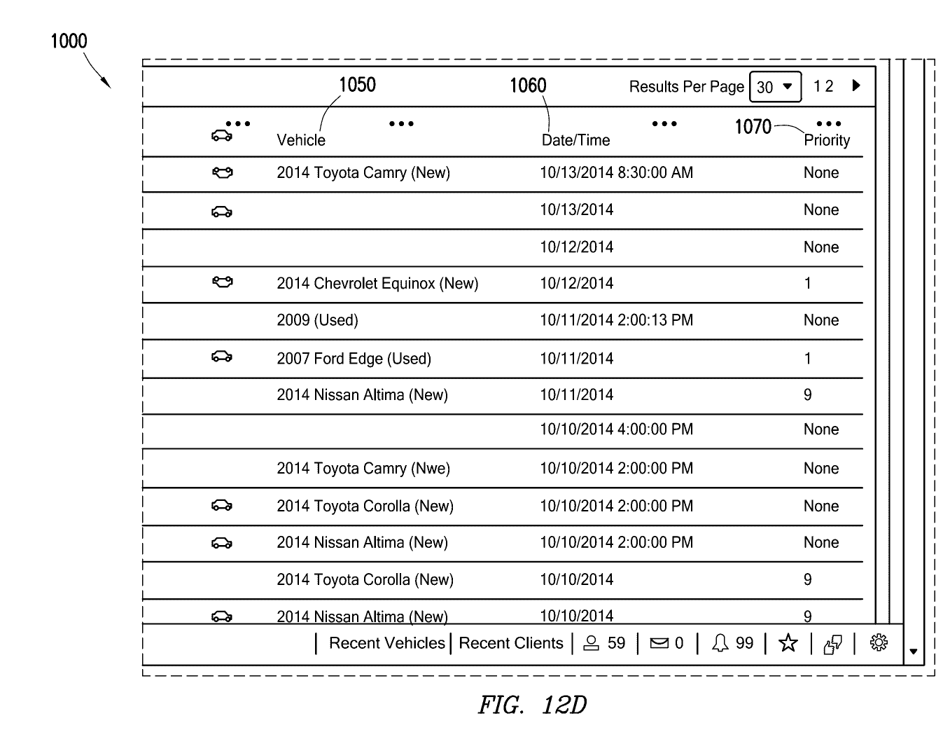

In some embodiments, actions 140 may be aggregated into a work plan for a user. FIGS. 12A-12D depict daily work plan GUI 1000. Daily work plan GUI 1000 may show for a given day the actions 140 assigned to a dealership employee. Daily work plan GUI 1000 may display information regarding actions 140 including, for example and without limitation, method of contact 1010, client name 1020, activity name 1030, vehicle 1050, date/time 1060 and priority 1070. Other action information may include whether the action is overdue, privacy settings, BDC User, category, click to call for manager, click to call for service advisor/user, score, secondary service advisor/user, source, and/or status. As one of ordinary skill in the art will appreciate, daily work plan GUI 1000 may instead be fashioned as a daily, weekly, or monthly plan. Further, in certain embodiments of the present disclosure, daily work plan actions may be filtered by daily work plan filters 1080. Non-limiting examples of such daily work plan filters 1080 are depicted on daily work plan GUI 1000, and may include, but are not limited to, days to display, group, business unit, status, contact method, category, and user.

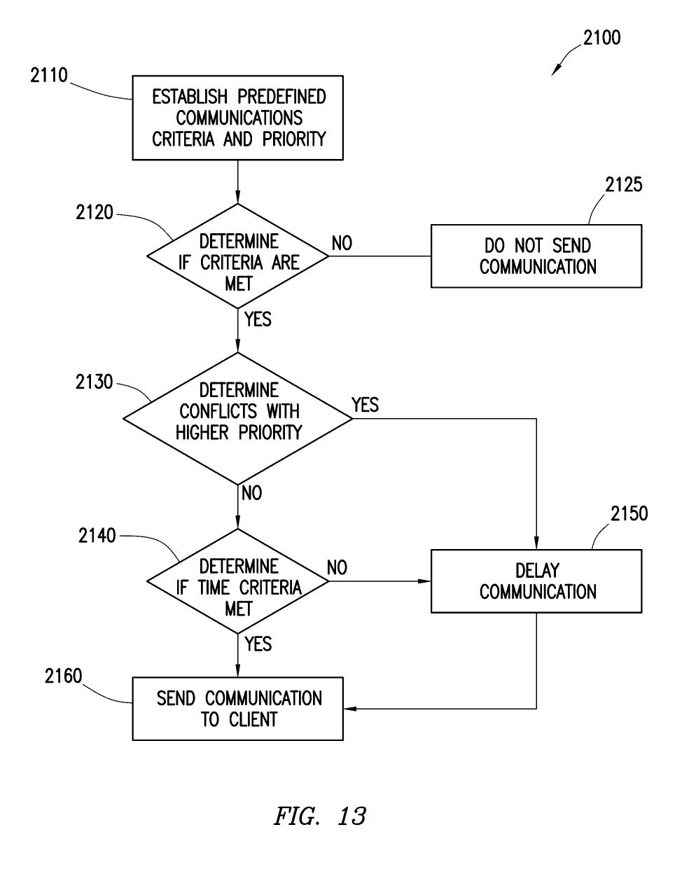

In another embodiment of the present disclosure, email, text, recorded dealership employee voice, or direct mail communications with existing clients may be generated based on predefined communications criteria established by, for instance, dealership personnel. The email, text, recorded dealership employee voice, and direct mail communications may be stored on a non-transitory, tangible computer readable storage medium. These email, text, recorded dealership employee voice, or direct mail communications with the existing client are sent without input from a dealership employee at the time of email, text, recorded dealership employee voice, or direct mail communication. In certain embodiments, at the time the email, text, recorded dealership employee voice, or direct mail communications to existing clients are sent, these email, text, recorded dealership employee voice, or direct mail communications do not include any action on the part of a dealership employee as “action 140” is described above. In this embodiment, as shown in FIG. 13, client communications algorithm 2100 includes as a first step establish predefined communications criteria and generate priority 2110. In establish predefined communications criteria and generate priority 2110, a series of possible email, text, recorded dealership employee voice, or direct mail communications with an existing client are created, associated with predefined communication criteria when such email, text, recorded dealership employee voice, or direct mail communication is to be sent, and a priority is generated. Examples of predefined communication criteria when such email, text, recorded dealership employee voice, or direct mail communications are to be sent may be based, for instance, on time since a pre-determined occurrence or on the number of miles calculated that a client's vehicle has been driven since a pre-determined occurrence. In some embodiments, the number of miles calculated that a client's vehicle has been driven may be estimated. In some embodiments, the number of miles calculated may be based in part on the service history of the client's vehicle. In some instances, such as where little or no service history is available, the estimated number of miles may be based on a default daily, monthly, or annualized mileage (“mileage”) since a previous date, such as a previous service appointment or purchase date. In some embodiments, the service history may be used to estimate the mileage based on the mileage reading at a first service date, the mileage reading at a second service date, and the number of days, months, years, or portions therof therebetween. By dividing the difference in mileage by the number of intervening time period, an average mileage may be determined. By multiplying the average mileage, whether calculated or a default is used, by the time period since the second service date, the total mileage of the existing client's vehicle may thus be estimated. Other non-limiting examples of predefined communication criteria are shown in Table 1 and Table 2 below. With respect to priority, any non-limiting scheme of prioritization may be used, including, but not limited to, the “high” or “regular” prioritization shown in Table 1 and Table 2 below:

TABLE 1
Service

| Communication | Date Range | Priority | Other Criteria |
|---|---|---|---|
| Service Manager | 7-365 days from | Regular | None |
| Introduction | purchase date | | |
| Service Invitation | 7-365 days from | Regular | No prior service history |
| | purchase date | | |
| Service Thank You | 0-20 days from date | High | None |
| | of service | | |
| First Service | Days based on | Regular | None |
| Reminder | estimated miles | | |
| | driven | | |
| Second Service | Days based on | Regular | Estimated mileage must be within the |
| Reminder | estimated miles | | Scheduled Maintenance Mileage Range; |
| | driven | | Vehicle must not have an upcoming |
| | | | appointment; Service Reminders must be |
| | | | at least 30 days apart. |
| Third Service | Days based on | Regular | Estimated mileage must be within the |
| Reminder | estimated miles | | Scheduled Maintenance Mileage Range; |
| | driven | | Vehicle must not have an upcoming |
| | | | appointment; Service Reminders must be |
| | | | at least 30 days apart. |
| Happy Birthday | 0-14 days before | High | None |
| | birthday | | |

TABLE 2
Sales

| Communication | Date Range | Priority | Other Criteria |
|---|---|---|---|
| Welcome to the | 0-30 days from | High | None |
| Dealership | purchase date | | |
| Sales Thank You | 0-30 days | High | None |
| | purchase date | | |
| Referral | 30-90 days from | Regular | None |
| | purchase date | | |
| Extended Service | 30-90 days from | Regular | No extended |
| Plan | purchase date | | warranty |
| Lease Renewal 18 | 525-555 days to | Regular | Existence of |
| months | end of lease date | | lease |
| Lease Renewal 1 | 15-45 days to | High | Existence of |
| month | end of lease date | | lease |
| Anniversary of | 350-380 days after | High | None |
| purchase (first year) | purchase date | | |

Other predefined communications criteria may limit the type of existing client or vehicle to which the email, text, recorded dealership employee voice, or direct mail communications are to be sent. For instance, such predefined communications criteria may include, but are not limited to the vehicle model year, make of the vehicle, model of the vehicle, condition of the vehicle (new, used, all), the existing client type (individuals, companies, all), sales type (lease, purchase, all), distance from existing client to the dealership, address of the existing client, and household history of purchases or sales of the existing client(first time buyer only, repeat buyer only, all). In some embodiments, a dealership may wish to conduct a campaign communication, wherein the dealership may select particular vehicles, types of existing clients or other particular campaign communication criteria and direct the communication to such clients as qualify for the campaign.

Once the email, text, recorded dealership employee voice, or direct mail communications, the predefined communications criteria, and the priority of the communication are established in establish predefined communication criteria and priority 2110, client communications algorithm 2100 includes as a second step determining if predefined communication criteria are met 2120 for one or more existing clients. In this step, client communications algorithm 2100 includes comparing the predefined communications criteria established in establish predefined communication criteria and priority 2110 with information about the existing client and the existing client's vehicle. Information about the existing client and the existing client's vehicle may be drawn from a database. As shown in client profile GUI 300, information, including, for example and without limitation, the existing client's name 310, existing client's address 320 and existing client contact information 330 may be entered into a database by a user, or, for existing clients who have had previous interactions with the dealership, may be drawn from existing databases. Other information related to existing clients and existing client vehicles may be drawn from existing databases or entered through a GUI.

If the predefined communications criteria are not met for an existing client, no email, text, recorded dealership employee voice, or direct mail communication is sent to that existing client as shown in do not send communication step 2125. If the predefined communication criteria are met for one or more email, text, recorded dealership employee voice, or direct mail communications, client communications algorithm 2100 determines conflicts with higher priority 2130. In certain embodiments, it may be desirable to avoid repeated communications with an existing client within a pre-determined period of time. For instance, it some embodiments, the pre-determined period of time may be, for instance, one month, two weeks, or one week. In the event that the criteria for a high priority and a regular priority communication are both met, the regular priority communication may be delayed, as shown in FIG. 13 in delay communication 2150. After the pre-determined period of time has lapsed, the regular priority communication may be send to the existing client, as shown by send communication to client 2160.

With reference back to determine conflicts with higher priority 2130, if there are no conflicts between a regular priority communication and a higher priority communication, client communications algorithm 2100 determines if there has been a previous communication in determine if time criteria are met 2140 within a pre-determined period of time, as described above with respect to determine conflicts with higher priority 2130. If the time criteria are not met, the email, text, recorded dealership employee voice, or direct mail communication is delayed, as described with respect to delay communication 2150. If the time criteria are met, the communication is sent to the client in send communication to client 2160.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method comprising:
(a) establishing predefined communications criteria and generating priority for a series of email, text, recorded dealership employee voice, or direct mail communications with an existing client;
(b) determining if the predefined communications criteria are met for a first communication of the series of communications, the first communication having a first priority;
(c) determining if the predefined communications criteria are met for any other communication of the series of communications having a higher priority than the first priority and, if one is so found, delaying the first communication, and if not:
(d) generating the first communication to the existing client; and
(e) sending the first communications to the existing client.

2. The method of claim 1, wherein the first communication is sent without an assigned action from results-based schedule to a dealership employee at the time the email, text, recorded dealership employee voice, or direct mail communications to the existing client is sent.

3. The method of claim 1, wherein the communications criteria comprise one or more of time since a pre-determined occurrence, a number of miles calculated that a vehicle associated with the client has been driven since the pre-determined occurrence, an existence of a lease, a lack of extended warranty, the vehicle model year, make of the vehicle, model of the vehicle, condition of the vehicle, the customer type, sales type, distance from client to the dealership, address of the client, household history of purchases or sales, or time since a previous communication.

4. The method of claim 3, wherein the number of miles is calculated by:
determining an average mileage;
determining the time period since the pre-determined occurrence; and
multiplying the average mileage by the time period.

5. The method of claim 1, wherein the possible communications comprise one or more of a service manager introduction, service invitation, service thank you, service reminder, happy birthday, welcome to the dealership, sales thank you, referral, extended service plan, lease renewal notice, or anniversary of purchase notice.

6. The method of claim 1, wherein operations (a)-(e) are repeated for a plurality of existing clients.

7. A method comprising:
(a) assigning a prospect associated with an existing client;
(b) generating a follow-up activity for the prospect, the follow-up activity being determined by a results-based schedule.
(c) assigning the follow-up activity to a user;
(d) carrying out the follow-up activity to generate at least one result; and
(e) repeating steps (b)-(d) based at least in part on the result.

8. The method of claim 7, wherein information about the existing client is entered through a GUI.

9. The method of claim 8, wherein the client profile may include one or more of the existing client's name, address, or contact information.

10. The method of claim 9, wherein step (a) further comprises determining if the existing client is a duplicate client.

11. The method of claim 7, wherein the follow-up activity is generated based at least in part on a client privacy preference.

12. The method of claim 11, wherein the client privacy preference comprises at least one of a do not call flag or a contact consent.

13. The method of claim 12, further comprising contacting the existing client via a contact method, the contact method including email, phone, direct mail, text, or recorded voice.

14. The method of claim 7, wherein the follow-up activity is generated based at least in part on an interaction with the existing client.

15. The method of claim 14, wherein the interaction is a negative interaction that generates a client care issue.

16. The method of claim 15, further comprising displaying information relating to a client care issue on a client profile client care GUI.

17. The method of claim 16, wherein the information comprises at least one of a status of the issue, a description of the issue, an assigned owner of the issue, and when the negative interaction occurred.

18. The method of claim 7, further comprising generating a work plan for the user.

19. The method of claim 18, wherein the work plan includes follow-up activities assigned to the user.

20. The method of claim 19, wherein the work plan includes follow-up activities for a predetermined time period.

21. The method of claim 20, wherein the time period corresponds to a day, week, or month.

22. The method of claim 19, wherein the work plan is adapted to be filterable by at least one of a time period, a group, a business unit, a status, a contact method, a category, or a user.
